(19) United States
(12) Patent Application Publication
(10) Pub. No.: US 2020/0079418 A1
(43) Pub. Date: Mar. 12, 2020

(54) ISOLATED STEERING RACK YOKE

(71) Applicant: Ford Global Technologies, LLC, Dearborn, MI (US)

(72) Inventors: James Philip Cooper, Milford, MI (US); Jack E. Barry, Dearborn, MI (US); Rohit Kadam, Windsor/Ontario (CA); Daniel Steven Payne, Southgate, MI (US); Joseph Washnock, Canton, MI (US); Jennifer Laz, West Bloomfield, MI (US)

(73) Assignee: Ford Global Technologies, LLC, Dearborn, MI (US)

(21) Appl. No.: 16/128,862

(22) Filed: Sep. 12, 2018

(51) Int. Cl. B62D 3/12; F16H 55/28; B62D 7/22

(52) U.S. Cl. CPC B62D 3/123; B62D 7/228; F16H 55/283

(57) ABSTRACT

An assembly includes a housing and a steering rack supported by the housing. The assembly includes a plug supported by the housing. The assembly includes a yoke supported by the housing between the steering rack and the plug. The assembly includes a monolithic dampener between the plug and the yoke, the monolithic dampener extending away from the plug toward the steering rack along the yoke.

### BACKGROUND

A steering assembly controls a steering angle of wheels of a vehicle. The steering assembly may include a steering wheel coupled to a rack and pinion assembly designed to control the steering angle. The steering assembly may include an electric motor coupled to the rack and pinion assembly.

### BRIEF DESCRIPTION OF THE DRAWINGS

FIG. 1 is a perspective view of a vehicle having a steering assembly.

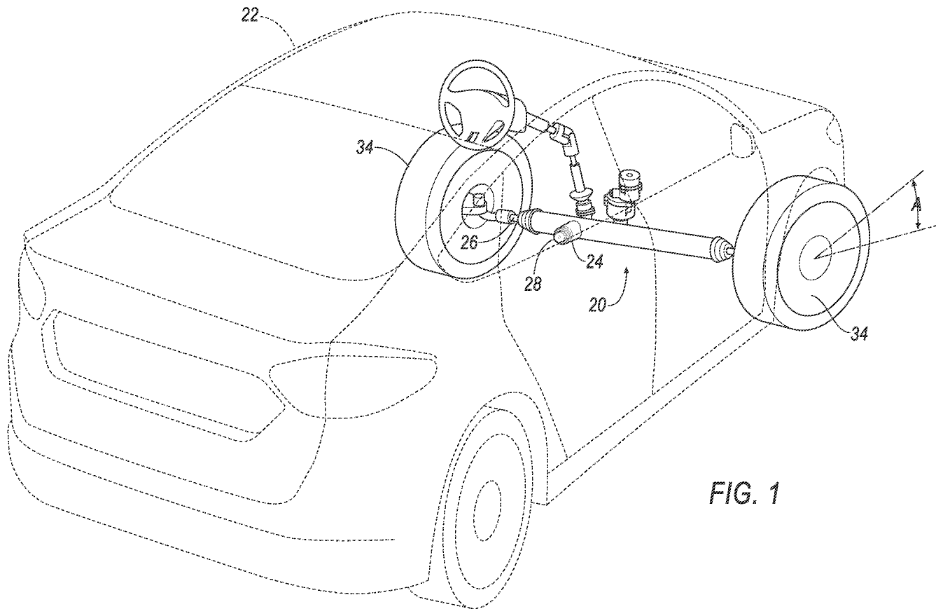

FIG. 2 is a cross section of the steering assembly.

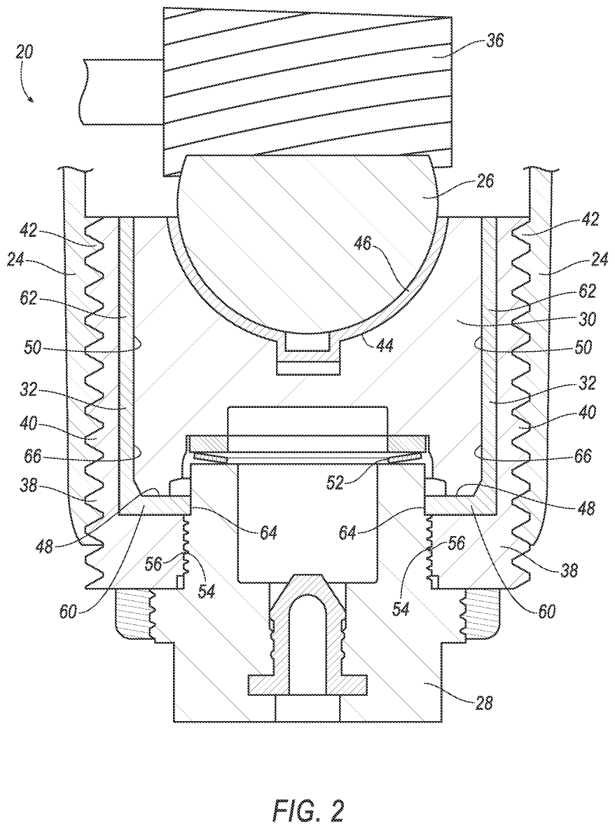

FIG. 3 is a perspective exploded view of components of the steering assembly.

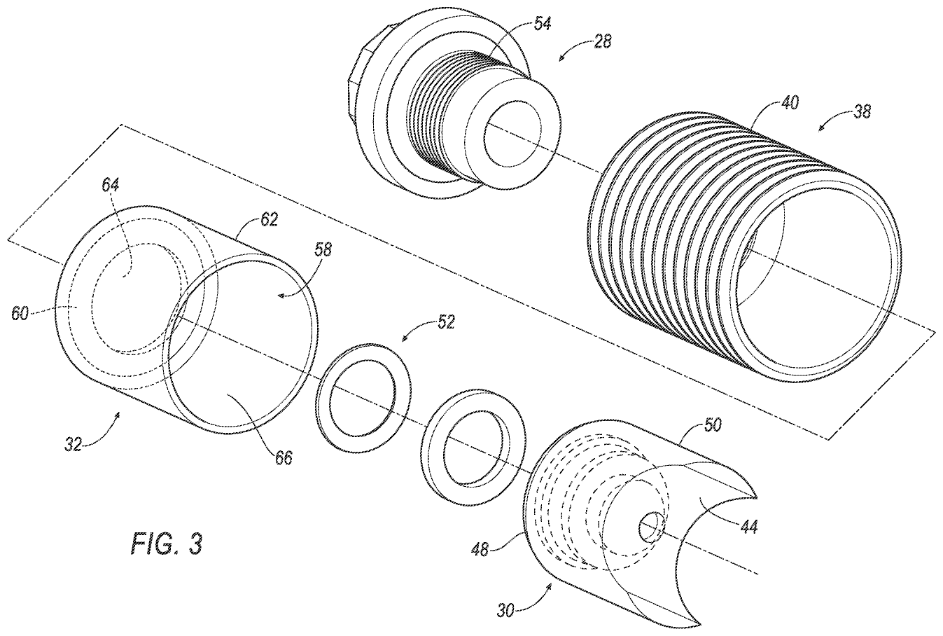

### DETAILED DESCRIPTION

An assembly includes a housing and a steering rack supported by the housing. The assembly includes a plug supported by the housing. The assembly includes a yoke supported by the housing between the steering rack and the plug. The assembly includes a monolithic dampener between the plug and the yoke, the monolithic dampener extending away from the plug toward the steering rack along the yoke.

The monolithic dampener may surround the yoke.

The assembly may include a gear meshed with the steering rack, the steering rack between the gear and the yoke.

The monolithic dampener may be bonded to the yoke.

The assembly may include a bearing between the yoke and the steering rack.

The assembly may include a spring between the plug and the yoke.

The monolithic dampener may define a hole, and the plug may be disposed within the hole.

The monolithic dampener may be cup shaped.

The yoke may have a distal end opposite the steering rack, the monolithic dampener extending along the distal end.

The assembly may include a nest supported by the housing, the monolithic dampener and the yoke supported by the nest.

The plug may be supported by the nest.

The nest may be between the plug and the yoke.

The nest may be between the plug and the housing.

The nest may be threadedly engaged with the housing.

The plug may be threadedly engaged with the nest.

The monolithic dampener may be plastic.

The monolithic dampener may be over-molded to the yoke.

The monolithic dampener may be friction fit to the yoke.

With reference to the Figures, wherein like numerals indicate like parts throughout the several views, a rack and pinion assembly 20 for controlling a steering angle A of a vehicle 22 includes a housing 24 and a steering rack 26 supported by the housing 24. The rack and pinion assembly 20 includes a plug 28 supported by the housing 24. The rack and pinion assembly 20 includes a yoke 30 supported by the housing 24 between the steering rack 26 and the plug 28. The rack and pinion assembly 20 includes a monolithic dampener 32, i.e., a single piece of material with no seams, joints, fasteners, or adhesives holding the monolithic dampener 32 together. The monolithic dampener 32 is between the plug 28 and the yoke 30, the monolithic dampener 32 extending away from the plug 28 toward the steering rack 26 along the yoke 30. The monolithic dampener 32 reduces noise and vibration generated by the rack and pinion assembly 20.

The vehicle 22 may be any passenger or commercial automobile such as a car, a truck, a sport utility vehicle, a crossover vehicle, a van, a minivan, a taxi, a bus, etc.

The vehicle 22 includes wheels 34. The wheels 34 may define the steering angle A. The steering angle A of the wheels 34, e.g., turned to a right or a left relative to a forward driving direction, controls a driving direction of the vehicle 22, e.g., when the wheels 34 are turned to the right the vehicle 22 may navigate to the right.

The rack and pinion assembly 20 controls the steering angle A of the wheels 34. The rack and pinion assembly 20 may be in communication with and receive input from a steering wheel and/or a computer. For example, the rack and pinion assembly 20 may be an electric power-assisted system, a steer-by-wire system, or other suitable system.

The rack and pinion assembly 20 controls the steering angle A of the wheels 34 via the steering rack 26. For example, the steering rack 26 may be connected to the wheels 34 via tie-rods, steering knuckles, etc., and may be movable toward the right and the left of the vehicle 22. Movement of the steering rack 26 may change the steering angle A. The steering rack 26 may include a plurality of gear teeth arranged along a length of the steering rack 26. The steering rack 26 may be slidably supported by the housing 24. For example, the steering rack 26 may slide within the housing 24 as the steering rack 26 moves to change the steering angle A.

A pinion gear 36 may be meshed with the steering rack 26. For example, gear teeth of the pinion gear 36 may be meshed with the gear teeth of the steering rack 26. Rotation of the pinion gear 36 may cause movement of the steering rack 26. For example, torque from rotation of the pinion gear 36 may be transferred to translational movement of the steering rack 26 via the gear teeth. The steering wheel may be coupled to the pinion gear 36, e.g., via a steering column, intermediary shaft, universal joint, etc., such that rotation of the steering wheel causes rotation of the pinion gear 36. The pinion gear 36 may be rotatably supported by the housing 24.

The housing 24 supports components of the rack and pinion assembly 20, e.g., the steering rack 26, the pinion gear 36, the yoke 30, the plug 28, etc. The housing 24 may be supported by another component of the vehicle 22, e.g., a frame, a body, etc. The housing 24 may be metal, or any suitable material.

The rack and pinion assembly 20 may include a nest 38. The nest 38 enhances ease of assembling the rack and pinion assembly 20. For example, the yoke 30, monolithic dampener 32, plug 28, spring 52, etc., may be supported by the nest 38, e.g., as a sub-assembly. The nest 38, and the components supported by the nest 38, may be supported by the housing 24. For example, an outer surface of the nest 38 may have threads 40 that mesh with threads 42 of the housing 24. In other words, the nest 38 may be threadedly engaged with the housing 24. The nest 38 may be between the plug 28 and the yoke 30. The nest 38 may be between the plug 28 and the housing 24.

The yoke 30 aids in maintaining the mesh between the steering rack 26 and the pinion gear 36, e.g., by urging the steering rack 26 toward the pinion gear 36. The yoke 30 may be opposite the pinion gear 36 relative to the steering rack 26. In other words, the steering rack 26 may be between the pinion gear 36 and the yoke 30. The yoke 30 may include a reaction surface 44. The reaction surface 44 may abut the steering rack 26. The reaction surface 44 may be adjacent the steering rack 26, e.g., with a bearing 46 or the like between the yoke 30 and the steering rack 26. The bearing 46 reduces friction between the yoke 30 and the steering rack 26, e.g., as the steering rack 26 slides within the housing 24 to control the steering angle A. The bearing 46 may be brass or any other suitable material.

The yoke 30 may include a distal end 48 opposite the reaction surface 44. In other words, the distal end 48 may be opposite the steering rack 26 relative to the yoke 30. For example, the distal end 48 may be spaced from the steering rack 26 with the reaction surface 44 therebetween. The distal end 48 faces away from the steering rack 26. The yoke 30 may include an outer surface 50 that extends transversely from the distal end 48 to the reaction surface 44.

The plug 28 aids the yoke 30 in maintaining the mesh between the steering rack 26 and the pinion gear 36. For example, the rack and pinion assembly 20 may include a spring 52 between the plug 28 and the yoke 30. The spring 52 may be under compression and urge the yoke 30 away from the plug 28 toward the steering rack 26. The spring 52 may be a spring washer, a coil spring or any suitable type. The spring 52 may abut the distal end 48 of the yoke 30.

The plug 28 is supported by the housing 24. For example, the plug 28 may be supported by the nest 38. The plug 28 may be supported by the nest 38 and/or housing 24 opposite the steering rack 26 relative to the yoke 30. In other words, yoke 30 may be supported by the housing 24 between the steering rack 26 and the plug 28. An outer surface of the plug 28 may have threads 54 that mesh with threads 56 of the nest 38. In other words, the plug 28 may be threadedly engaged with the nest 38. Rotation of the plug 28 relative to the housing 24 and/or nest 38 may move the plug 28 toward or away from the steering rack 26, e.g., depending on a rotation direction of the plug 28. Moving the plug 28 toward or away from the steering rack 26 compresses or decompresses the spring 52, respectively, e.g., to increase or decrease force applied by the yoke 30 to the steering rack 26.

The monolithic dampener 32 reduces noise and vibration created by the rack and pinion assembly 20. For example, the monolithic dampener 32 may reduce contact between the yoke 30 and the nest 38, the yoke 30 and the housing 24, the yoke 30 and the plug 28, etc. The monolithic dampener 32 may dampen vibrations of the yoke 30 generated during operation of the vehicle 22. The monolithic dampener 32 may be plastic, rubber, or any suitable material having sufficient dampening properties.

The monolithic dampener 32 is “monolithic” in that the monolithic dampener 32 is a single piece of material with no seams, joints, fasteners, or adhesives holding the monolithic dampener 32 together. The monolithic dampener 32 provides a reduction in noise in multiple directions, e.g., axially and radially relative to the yoke 30, with a single component, e.g., simplifying design and assembly of the rack and pinion assembly 20. The monolithic dampener 32 further enables consistent placement of dampener material relative to the yoke 30. For example, the monolithic dampener 32 may be held in place relative to the outer surface 50 of the yoke 30 via securing the monolithic dampener 32 at the distal end 48 of yoke 30, and vice versa.

The monolithic dampener 32 is between the plug 28 and the yoke 30. For example, monolithic dampener 32 may be between the distal end 48 of the yoke 30 and the plug 28. The monolithic dampener 32 may extend along the distal end 48. For example, the monolithic dampener 32 may extend across the distal end 48 from where the distal end 48 meets the outer surface 50 at one location to where the distal end 48 meets the outer surface 50 at another location. As another example, the monolithic dampener 32 may extend from where the distal end 48 meets outer surface 50 toward a center of the distal end 48.

The monolithic dampener 32 extends away from the plug 28 toward the steering rack 26 along the yoke 30. For example, the monolithic dampener 32 may extend along the outer surface 50 from where the distal end 48 meets outer surface 50 toward the reaction surface 44. The monolithic dampener 32 may surround the yoke 30. For example, the monolithic dampener 32 may extend around the outer surface 50, enclosing the yoke 30 therein.

The monolithic dampener 32 may be cup shaped. The cup shape may define a cavity 58. The yoke 30 may be in the cavity 58. For example, a bottom 60 of the cup shape may be at the distal end 48, and sides 62 of the cup shape may extend along the outer surface 52.

The monolithic dampener 32 may define a hole 64. The hole 64 may be at the distal end 48 of the yoke 30. For example, the hole 64 may be at the bottom 60 the of cup shape. The hole 64 enables the spring 52 to urge the yoke 30 toward the steering rack 26 without dampening from the monolithic dampener 32. For example, the plug 28 may be disposed within the hole 64. In other words, the plug 28 may extend through the hole 64 toward the yoke 30. Alternately or additionally, the spring 52 may extend through the hole 64 (not shown).

The monolithic dampener 32 may be bonded to the yoke 30 to prevent relative motion therebetween. For example, an inner surface 66 of the monolithic dampener 32 may be bonded to the outer surface 50 of yoke 30, e.g., with an adhesive.

The monolithic dampener 32 may be friction fit to the yoke 30 to prevent relative motion therebetween. For example, a diameter, width, etc., of the inner surface 66 of the cup may be smaller than a diameter, width, etc., of the outer surface 50 of the yoke 30. In other words, the inner surface 66 of the monolithic dampener 32 may be sized to have an interference fit with the outer surface 50 of the yoke 30. The monolithic dampener 32 may stretch to surround the yoke 30.

The monolithic dampener 32 may be over-molded to the yoke 30. In other words, the monolithic dampener 32 has the characteristics of being over-molded, e.g., is formed to the yoke 30 as a single, uniform piece of material with no seams, joints, fasteners, or adhesives holding the monolithic dampener 32 and yoke 30 together. As one example, the yoke 30 is placed in an injection mold and material is injected into the injection mold to form the monolithic dampener 32. In examples where the monolithic dampener 32 is over-molded to the yoke 30, the monolithic dampener 32 has a structural shape that is congruent with the yoke 30. For example, the monolithic dampener 32 that is over-molded to the yoke 30 eliminates any gaps and/or spacing between the monolithic dampener 32 and the outer surface 50 of the yoke 30, and eliminates relative motion therebetween that may be caused from forming the monolithic dampener 32 independent of the yoke 30.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An assembly, comprising:
a housing;
a steering rack supported by the housing;
a plug supported by the housing;
a yoke supported by the housing between the steering rack and the plug; and
a monolithic dampener between the plug and the yoke, the monolithic dampener extending away from the plug toward the steering rack along the yoke.

2. The assembly of claim 1, wherein the monolithic dampener surrounds the yoke.

3. The assembly of claim 1, further comprising a gear meshed with the steering rack, the steering rack between the gear and the yoke.

4. The assembly of claim 1, wherein the monolithic dampener is bonded to the yoke.

5. The assembly of claim 1, further comprising a bearing between the yoke and the steering rack.

6. The assembly of claim 1, further comprising a spring between the plug and the yoke.

7. The assembly of claim 1, wherein the monolithic dampener defines a hole, and the plug is disposed within the hole.

8. The assembly of claim 1, wherein the monolithic dampener is cup shaped.

9. The assembly of claim 1, wherein the yoke has a distal end opposite the steering rack, the monolithic dampener extending along the distal end.

10. The assembly of claim 1, further comprising a nest supported by the housing, the monolithic dampener and the yoke supported by the nest.

11. The assembly of claim 10, wherein the plug is supported by the nest.

12. The assembly of claim 11, wherein the nest is between the plug and the yoke.

13. The assembly of claim 10, wherein the nest is between the plug and the housing.

14. The assembly of claim 10, wherein the nest is threadedly engaged with the housing.

15. The assembly of claim 10, wherein the plug is threadedly engaged with the nest.

16. The assembly of claim 1, wherein the monolithic dampener is plastic.

17. The assembly of claim 1, wherein the monolithic dampener is over-molded to the yoke.

18. The assembly of claim 1, wherein the monolithic dampener is friction fit to the yoke.
